(19) United States
(12) Patent Application Publication
(10) Pub. No.: US 2016/0251818 A1
(43) Pub. Date: Sep. 1, 2016

(54) APPARATUS FOR SECURING, IN PARTICULAR REMEDIATING, THE FOUNDATION OF A WIND TURBINE, AS WELL AS FOUNDATION AND METHOD FOR REMEDIATING

(71) Applicant: WPT Nord GmbH, Kiel (DE)

(72) Inventor: Ralf Thomsen, Sprenge (DE)

(73) Assignee: WPT Nord GmbH, Kiel (DE)

(21) Appl. No.: 15/053,761

(22) Filed: Feb. 25, 2016

(30) Foreign Application Priority Data
Feb. 26, 2015 (DE) 202015100932.1
Feb. 26, 2015 (EP) 15156696.5

(51) Int. Cl. E02D 31/08; E02D 27/50; F03D 7/02; E02D 27/42

(52) U.S. Cl. CPC E02D 31/08; E02D 27/425; E02D 27/50; F03D 11/045; F03D 7/0296

(57) ABSTRACT

The present invention relates to a securing device (100) for additionally securing a foundation (1) having a foundation mounting part (6) that is incorporated in a concrete structure (2) for holding a construction (14), in particular a tower of a wind turbine, wherein the securing device (100) includes at least one securing structure (102, 104, 106) with a mounting section (108, 110, 112) and a support section (114, 116, 118). According to the invention, the mounting section (108, 110, 112) for mounting the securing structure (102, 104, 106) is provided on the foundation mounting part (6) and the support section (114, 116, 118) for introducing foundation forces is provided in a section (23) of the concrete structure (2) that is distant of the foundation mounting part (6). The invention further relates to a foundation and method.

The present invention relates to a securing device for additionally securing a foundation having a foundation mounting part that is incorporated in a concrete structure for holding the construction, in particular a tower of a wind turbine (WT). The present invention further relates to a foundation for said construction, in particular a tower of a wind turbine with a concrete structure and a foundation mounting part incorporated therein having an essentially cylindrical base body at which at least one ring flange extends that serves as an axial anchoring for the foundation mounting part in the concrete structure, with the central axis of the foundation mounting part being essentially installed in vertical direction. The present invention further relates to a method for securing a foundation for a construction, in particular a tower of a wind turbine.

The need for erecting wind turbines is ever increasing, if nothing else than because of the so-called energy turnaround. Both tower heights and wind turbine performance have increased steadily, making greater demands on foundations. Not only must the foundations hold the great weight, but they must, in particular, withstand dynamic loads. The force of the wind is applied near the hub of the wind turbine and creates a moment at the tower base. Said moment must be absorbed by the foundation. At the same time, said moment varies as the turbine rotates, creating a swinging load in the foundation.

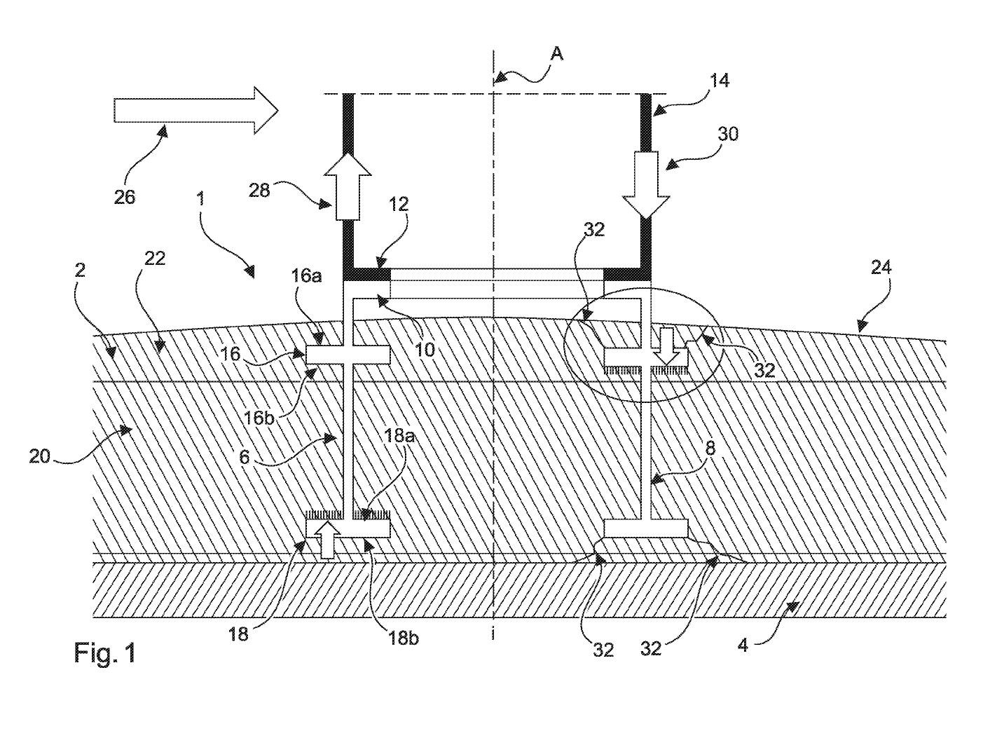

Common wind turbine foundations have a foundation mounting part that is cast in a concrete structure. Normally, the foundation mounting part is made of steel and the concrete is reinforced with steel bars. Normally, the foundation mounting part has an essentially cylindrical or tubular base body with two axially spaced apart ring flanges extending. Both ring flanges are installed in the concrete structure such that the central axis of the cylindrical base body is essentially aligned vertically. An upper end of the foundation mounting part lies above the surface and has a connection flange, to which the wind turbine tower is flange-mounted. Normally, a reinforcement cage is provided externally around the foundation mounting part between the two ring flanges. The lower ring flange serves to lead the moments (occurring, in particular, on the side facing the wind) as compressive forces upwards into the concrete structure, and the upper ring flange rests from above on the subjacent section of the concrete. A typical stress situation is shown in FIG. 1.

This type of mounting and the described stress result in various problems. One well-known problem associated directly with the mounting is that the concrete will shrink when hardening. Every concrete will undergo (albeit minor) shrinkage when hardened, which may produce cavities or cracks in axial direction along the foundation mounting part between the two ring flanges. As a result, the lower ring flange cannot find adequate support in upward direction and the upper ring flange cannot find adequate support in downward direction. This provides the foundation mounting part with slight clearance, resulting in the entire construction moving when under stress.

Other known problems include cracking due to fatigue that is partly promoted by faulty installation (formation of cavities) or faulty execution of concrete joints.

Various concepts of how to correct such errors are known. For example, on pages 24 to 30 in the magazine “Erneuerbare Energien” [Renewable Energies] from February 2009, Bosse suggests lifting the entire construction together with the foundation mounting part by means of hydraulic presses and lining the upper ring flange with a swellable, fast-hardening concrete replacement. Cavities should be filled with synthetic resins, which when grouted under high pressure and having low viscosity can enter even the tiniest cavities. However, the disadvantage here is that such concrete replacements are normally based on expansion due to entrained gas bubbles making such material hardly pressure resistant and quite fatigue critical. Using such material may improve the situation in the short run, but not permanently.

A similar remediation concept has been introduced by the company Vestas Wind System A/S, which suggests a three-level method depending on the type of damage. First, injection wells running skew to the foundation mounting part are provided both radially outside and radially inside the foundation mounting part to inject concrete to the lower flange. Radially outside the upper flange it is partly exposed and the concrete is completely exchanged. Finally, hydraulic presses can be additionally provided at the upper ring flange, providing further support to said upper ring flange, between the lower surface of the ring flange and the concrete structure in order to lift the tower. However, they will hold the foundation mounting part and construction in position only during the repair work and will be removed once the cavities have been filled with concrete. These processes are, however, very complex and will weaken the concrete structure even more because of the introduction of injection wells.

Another thing that all known remediation concepts have in common is that they are or can be employed only once the damage has occurred. They can hardly, or cannot, be used in prevention.

The object of the present invention is thus to provide a securing device, a foundation and a method of the above-described type that can be used both in prevention and for remediating defective foundations and provide a permanent, cost-efficient solution for securing the remediation of a foundation of a construction. The particular idea behind this solution is to waive the use of additional concrete or concrete replacement.

With a securing device of the initially described type for additionally securing a foundation, the object is solved by the features of claim 1 and thus, in particular, by at least one securing structure having a mounting section and a support section, wherein the mounting section for mounting the securing structure is provided on the foundation mounting part and the support section for introducing foundation forces is provided in a section of the concrete structure distant of the foundation mounting part.

The invention is based on the finding that a foundation can be additionally secured by introducing foundation forces to areas that are not themselves loaded, or are loaded only a little, by the foundation mounting part. It has shown that the area of the concrete structure extending in axial direction above or below the ring flanges of the foundation mounting part or in the direct vicinity is loaded most, while areas distant of the foundation mounting part are often essentially unloaded. This is why said sections of the concrete structure are ideal for introducing at least part of the foundation forces to them.

A remote section of the concrete structure in terms of the invention is a section extending about the foundation mounting part, preferably arranged radially outside and axially adjacent to any ring flanges or other anchoring elements provided at the foundation mounting part. Preferably, the remote section is approx. 10 cm to 80 cm, preferably 30 cm to 60 cm, particularly preferably approx. 40 cm shy of a ring flange or other anchoring element of the foundation mounting part in radial direction. Preferentially, one diameter of the remote area is approx. 1.3 to 2.5 times, in particular 1.5 to 2.0 times, particularly preferably approx. 1.7 times the diameter of the foundation mounting part. Said measure may also depend on the exact dimension of a piece of reinforcement in the concrete that is to absorb supporting forces.

Particularly preferably, the securing device is used as a remediation device for remediating a damaged foundation. If the above-described damages have already occurred in a foundation and, for example, cavities or cracks have already formed in axial direction of the ring flange of the foundation mounting part, the securing device according to the invention is preferably used for remediating such a foundation. Preferentially, the support section serves for introducing foundation forces to an intact section of the concrete structure distant of the foundation mounting part. An intact section of the concrete structure is a section showing no, or no major, signs of fatigue and no defective concrete joints or cracks.

Although the invention can be used in a particularly advantageous and economic manner for wind turbines, it is not limited to them. Instead, a securing device for additional securing of a foundation according to the invention can be used in comparable stress situations for comparable foundations having a foundation mounting part that is installed in a concrete structure. Constructions that are affixed to such a foundation mounting part include, but are not limited to, machines, in particular chamfering machines, large-scale machines, presses, power poles, transmitter masts, bridge piers, pillars and the like. Employment of the securing device is particularly advantageous for dynamically loaded foundations. Preferably, the concrete structure is designed as a reinforced concrete structure and designed to absorb foundation forces. Other concrete types, such as prestressed concrete, fiber-reinforced concrete, textile concrete, reaction resin concrete and the like are also preferred.

In a first preferred embodiment, a maximum outer diameter of the securing structure is bigger than a maximum outer diameter of the foundation mounting part. Preferably, a maximum outer diameter of the securing structure is bigger than a maximum outer diameter of an upper ring flange or of another anchoring element of the foundation mounting part. Preferably, the maximum outer diameter of the securing structure is at least 5%, at least 10%, at least 15%, at least 20% bigger than the maximum outer diameter of the foundation mounting part.

In yet another preferred embodiment, the securing structure is designed as a ring segment, in particular as a half, third, or quarter ring segment. This embodiment is particularly preferred if the foundation mounting part has a cylindrical basic shape. If the foundation mounting part is rectangular, angular securing structures are preferably provided. The same is true for foundation mounting parts with a polygon basic shape, for example a hexagonal or octagonal shape, where correspondingly angular securing structures are provided for, as well. If the securing structure is designed as a ring segment, assembly is much easier. The securing structure is, for example, designed as a half ring segment. In that case, two securing structures are preferably used for the securing device according to the invention to jointly form a complete ring that is fastened to the outer circumference of the foundation mounting part by means of the mounting section of the securing structure.

The securing structure is preferably designed essentially even. Preferentially, the securing structure is made of sheet, in particular steel sheet. This is a particularly easy way of producing the securing structure. What is preferred, for example, is 50 mm thick steel sheet. It provides enough strength to secure the foundations of wind turbines. Other sheet thicknesses may be preferred as well, depending on the size of the foundation and construction that is attached to the foundation and of the type of forces that need to be absorbed. If the securing structure is essentially even, it is much easier to produce, transport, and assemble. This allows for reducing costs as compared to common securing and/or remediation concepts.

In a preferred further embodiment, the mounting section shows a first plurality of through holes for accepting fasteners for fastening the securing structure to the foundation mounting part. The fasteners are preferably designed as fastening screws. This is a particularly easy fastening option for the securing structure that can be easily installed even later on. It allows for providing corresponding fasteners at the foundation mounting part, in particular threaded holes. Fastening screws offer a certain elasticity which is advantageous when introducing foundation forces from the foundation mounting part to a remote section of the concrete structure by means of the securing structure. It may also be preferred to attach the securing structure to the foundation mounting part by means of a welded joint, but this has the disadvantage of distorting the material which may be harmful during dynamic load.

One preferred variant provides for arranging at least one reinforcing brace at the securing structure having one contact section that is provided to rest on one section of a foundation mounting part and/or on one construction arranged thereon. The arrangement of the reinforcing brace at the securing structure and its resting on one section of a foundation mounting part and/or on one construction arranged thereon has a reinforcing effect on the securing structure. The reinforcing brace is preferably provided to support the securing structure to absorb, at least in part, any foundation forces that are introduced. The reinio forcing effect is achieved by the arrangement of at least one reinforcing brace per securing structure, which additionally absorbs the forces by resting on a foundation mounting part and/or on one construction arranged thereon. This can help to prevent an accidental “lofting” of the securing structure. Preferably, the contact section rests on an outer circumference of a flange, such as a connection flange of the foundation mounting part. Because of its radial dimension, such flange section is particularly suitable for supporting and absorbing forces. Two or more, in particular five or more, reinforcing braces are preferably arranged at a securing structure. It is preferred to provide the reinforcing braces such that they essentially have the same distance to each other. When installed, the reinforcing brace preferably extends essentially vertically upwards from the securing structure.

In yet another preferred embodiment, the reinforcing brace is designed as a gusset plate that extends essentially vertically to a flat extension of the securing structure. The gusset plate is affixed to the securing structure, preferably by means of a substance-to-substance bond, such as a welded joint. The gusset plate is mainly made of steel, preferably of steel sheet. The surfaces of the gusset plate can be designed as closed or at least partially open surfaces with recesses and/or openings. Partially open surfaces have the advantage of little weight and material savings.

In yet another particularly preferred embodiment, it is provided for the support section of the securing structure to show at least one take-up unit for a support unit. The support unit is preferably designed to support the securing structure on the remote section of the concrete structure and to pretension the securing structure in a vertical direction. The support unit can be provided in one piece at the support section of the securing structure, or it can be connected therewith in a reversibly detachable fashion. The support unit provides for a particularly preferred coupling between the support section and the concrete structure. Moreover, with the support unit one can achieve a targeted pretension of the support section in vertical direction, i.e. traction onto the foundation mounting part vertically upwards and thus out of the concrete structure. This is preferred in order to press a lower ring flange or another lower anchoring element with its surface pointing in an axially upward direction against one section of the concrete structure to thus reduce clearance and achieve force transmission into the concrete structure and to, at the same time, reduce maneuverability of the foundation mounting part relative to the concrete structure. This will improve the overall security of the foundation and provide for permanent attachment.

In one preferred further embodiment, the take-up unit for the support unit has a second plurality of through holes. The second plurality of through holes serves, in particular, to accept the support unit at least in part and to thus establish a frictional and/or positive connection between the support unit and the support section of the securing structure.

It is further preferred for the contact section of one above-described securing device with at least one reinforcing brace to have a support unit. The support unit at the contact section of the reinforcing brace and the support unit arranged at the support's take-up unit may be identical or similar and designed, in particular, in accordance with one of the following aspects.

In one preferred variant, the support unit shows at least one pressure screw with a spherical disk. Preferably, the through holes of the take-up unit have female threads to take up the pressure screw. Preferably, the spherical disk of the pressure screw rests directly on the concrete structure. To reduce seating stress, one can provide for one or more additional pressure pieces between the spherical disk and the concrete structure. Such pressure pieces can be designed, for example, as a metal sheet, especially as a steel sheet or the like, and serve to reduce seating stress to thus largely prevent the concrete structure from being damaged. The spherical disk always ensures even resting on the concrete structure or pressure piece. A spherical disk may compensate certain inclinations, which is advantageous especially in cases of dynamic load on the foundation.

Additionally or alternatively, the support unit has at least one hard rubber body that extends preferably flatly along the entire support section of the securing structure. The hard rubber body is provided to rest on the concrete structure in the remote section of the foundation mounting part. An axial thickness of the hard rubber body can be selected such that the foundation mounting part is stressed upwards in vertical direction to thus press the upwards facing surface of a lower ring flange or anchoring element that is arranged distally below the ground in the concrete structure against a section of the concrete structure. Also, a hard rubber body has the advantage of allowing minor movements thanks to its elasticity while, at the same time, reducing vibrations. This avoids excessive seating stress at the concrete structure while, at the same time, allowing for waterproofing. Moreover, a hard rubber body is a cost-efficient component which allows for an overall cost-efficient production of the securing device.

It is further preferred for the support unit to have, as an alternative or in addition, at least one spring element, in particular a disk spring. Preferably, the support unit has a plurality of disk springs. With disk springs, one can very easily and cost-efficiently achieve a pretension in vertical direction of the securing structure and hence of the foundation mounting part.

It is moreover preferred for the support unit to show, as an alternative or in addition, at least one hydraulic cylinder. Preferably, the support unit has a plurality of hydraulic cylinders that are very suited to adjust a pretension in vertical direction. A hydraulic supply for the hydraulic cylinders may be accommodated, for example, inside the tower of the wind turbine. Hydraulic cylinders can also be used for readjusting the pretension in case of subsidence or the like.

It is further preferred for the support unit to show, as an alternative or in addition, a vibration absorber, for example such as sold by the company ContiTech AG (Hanover) under the brand name Schwingmetall®. Such vibration absorbers can be easily connected to the support section of the securing structure by means of a screw fitting, they are inexpensive and designed for such loads.

In one preferred further embodiment, the support unit shows, in addition or as an alternative, at least one mounting foot. Mounting feet are also designed for such loads and they moreover have absorbing properties. They can be arranged in the support section in an advantageous fashion to achieve a connection between the securing structure and the concrete structure.

In yet another preferred embodiment, the support unit shows, in addition or as an alternative, at least one pair of tensioning wedges. Preferably, such pair of tensioning wedges consists of two tensioning wedges which in cross section have a shape equal to a right-angled triangle and whose sides defining the hypotenuse abut. The two tensioning wedges can be braced and displaced against each other by means of a tensioning device, such as a tensioning screw, so that two sides of the pair of tensioning wedges extending in essence parallel to the direction of tension can be moved away from each other. If the pair of tensioning wedges is provided at the securing structure such that one of the surfaces interacts with the support section and the other surface abuts the concrete structure, a pressing force can be applied by means of the tensioning wedges to thus load the foundation mounting part in a vertical direction. This is a simple solution in terms of mechanical engineering which also allows for readjustment and moreover constitutes an inexpensive alternative to hydraulic cylinders.

In one alternative further embodiment, the support section of the securing structure is designed to rest directly on the concrete structure's section that is distant of the foundation mounting part. Directly means that no other intermediate element, such as a support unit, is provided for. The support section of the securing structure rests directly on the concrete structure, wherein it is condoned that pollutants or surface preparation elements, such as grouting compound, may be present at the concrete structure. In individual cases, this embodiment of the securing device is preferably realizable in a very cost-efficient manner.

In another aspect of the invention with a foundation of the initially mentioned type, the initially mentioned object is solved by means of a remediation device having the features of at least one of the above-described preferred embodiments of a securing device pursuant to the first aspect of the invention. As regards the advantages and preferred embodiments, full reference is made to the above description.

Preferably, the foundation mounting part has at least two axially spaced apart ring flanges. Preferably, the concrete structure has moreover a steel reinforcement—at least axially between the two ring flanges. This allows for good anchorage. Other anchoring elements instead of ring flanges can be provided for, such as interrupted flanges that are also embraced by the term “ring flange”.

In a first preferred embodiment of the foundation, the foundation mounting part shows at least two axially spaced apart ring flanges at the base body, with the securing structure being attached to the upper of the two ring flanges. This ensures a particularly good securing of the foundation. The upper ring flange of the foundation mounting part is essentially loaded from its surface facing downwards. Normally, it is arranged close to the surface and covered only with a comparatively thin concrete layer which usually is not reinforced. The lower ring flange, on the other hand, is grouted in the concrete structure below the ground and approx. 1 to 2 meters away from the upper ring flange. The lower ring flange is essentially loaded from its upper surface. Reinforcement is normally arranged above the upper surface of the lower ring flange. This is why it is much easier to attach the securing structure to the upper ring flange. On the other hand, attaching the securing structure to the upper ring flange can be loaded in an easier fashion, namely by having the securing structure rest on a surface of the concrete structure together with the support section. It is not necessary to install the securing structure in the concrete structure. An additional cover, in particular for protecting the connection between the foundation mounting part and the securing structure, can be provided for but is not mandatory.

According to yet another preferred embodiment of the foundation, the upper ring flange has a plurality of threaded holes for accepting fastening screws. By means of said threaded holes, the securing structure can be attached to the foundation mounting part via the mounting section. Blind holes are particularly preferred, as they can provide a certain level of protection against penetrating water thus contributing to a permanent solution. Also, blind holes are easier to make than through holes as they require less material to be removed. Otherwise, there would be a risk of the boring machine being damaged by the subjacent concrete.

According to a preferred embodiment of the foundation, at least one pressure piece for transmitting foundation forces from the support section into the concrete structure is provided between the support section and the concrete structure. Said pressure piece is preferably designed as a metal plate, in particular a steel plate, to avoid or reduce seating stress between the support section and the concrete structure.

Preferably, the pressure piece is attached to the concrete structure's section that is distant of the foundation mounting part by means of a grouting compound in an essentially horizontal direction. One can use any type of suitable grouting compound, for example a resin. This will allow for an advantageous introduction of supporting forces into the concrete structure.

According to a third aspect of the invention, the initially mentioned object in case of a method of the initially mentioned type for securing a foundation for a construction, in particular a tower of a wind turbine with a concrete structure and a foundation mounting part incorporated therein having a base body at which at least one ring flange extends that serves as an axial anchoring for the foundation mounting part in the concrete structure, with the central axis of the foundation mounting part being essentially installed in vertical direction, is solved by the step of having the foundation mounting part rest on a section of the concrete structure that is distant of the foundation mounting part. Preferably, the base body is essentially cylindrical.

It is to be understood that the securing device according to the first aspect of the invention and the foundation according to the second aspect of the invention and the method according to the third aspect of the invention have a plurality of common aspects and preferred embodiments, as set forth, in particular, in the sub-claims. In this regard, full reference is made to the above description and the advantages presented therein. Having the foundation mounting part rest, in addition, on a remote section of the concrete structure that is distant of the foundation mounting part adds to an improved securing and permanent durability of the foundation. The term “remote section” is to be understood as defined hereinabove.

The method is particularly preferred for remediating a damaged foundation. As initially explained, if the foundation shows damages such damages can be rectified in an advantageous manner by means of the method according to the invention. It is not necessary to introduce additional concrete or concrete replacement in order to close cracks or cavities. The necessary stability is achieved by having the foundation mounting part rest on the concrete structure's remote section of the foundation mounting part. This makes remediation work much easier, which can be easily performed even later on.

According to a first preferred exemplary embodiment of the method, this method includes the step of attaching a securing device according to one of the above-described preferred embodiments of a securing device pursuant to the first aspect of the invention. Preferably, the securing device is attached to the upper ring flange of the foundation mounting part. Preferably, the step of having the foundation mounting part rest on a concrete structure's remote section of the foundation mounting part is achieved by means of the securing device pursuant to the first aspect of the invention.

In yet another preferred embodiment of the method, where at least two axially spaced apart ring flanges extend at the base body, the method includes the step of pressing the upper surface of the lower ring flange against a section of the concrete structure. This results in a particularly good securing of the foundation and permanent contact between the upper surface of the lower ring flange and the concrete structure. This leads to good force transmission into the concrete structure and avoids maneuverability of the foundation mounting part relative to the concrete structure. Preferably, this step is achieved by means of the above-described support unit. So, in order to lift the foundation mounting part it is no longer necessary to inject additional (expanding) concrete or concrete replacement under the lower ring flange through holes. Instead, the foundation mounting part is lifted “from above” by means of the securing device according to the invention and contact is (re-)established between the lower ring flange and the concrete structure.

According to yet another preferred embodiment of the method, this method includes the step of bracing the foundation mounting part upward in vertical direction. This, too, results in a particularly good securing and in a reduction of any cavities or cracks above the lower ring flange. Moreover, it reduces at least in part the load on the ring flanges or other anchoring elements.

It is further preferred for the method to include at least one of the following steps: exposing an upper surface of the upper ring flange; adding a plurality of threaded holes to the upper surface of the upper ring flange; pressing, by means of a support unit, against the support section to brace the foundation mounting part; arranging at least one pressure piece on a surface of the concrete structure's remote section of the foundation mounting part.

The invention will be described in more detail below with reference to the enclosed figures, wherein:

FIG. 1 is a schematic cross-sectional view of a foundation with a wind turbine tower pursuant to prior art arranged therein showing typical defects;

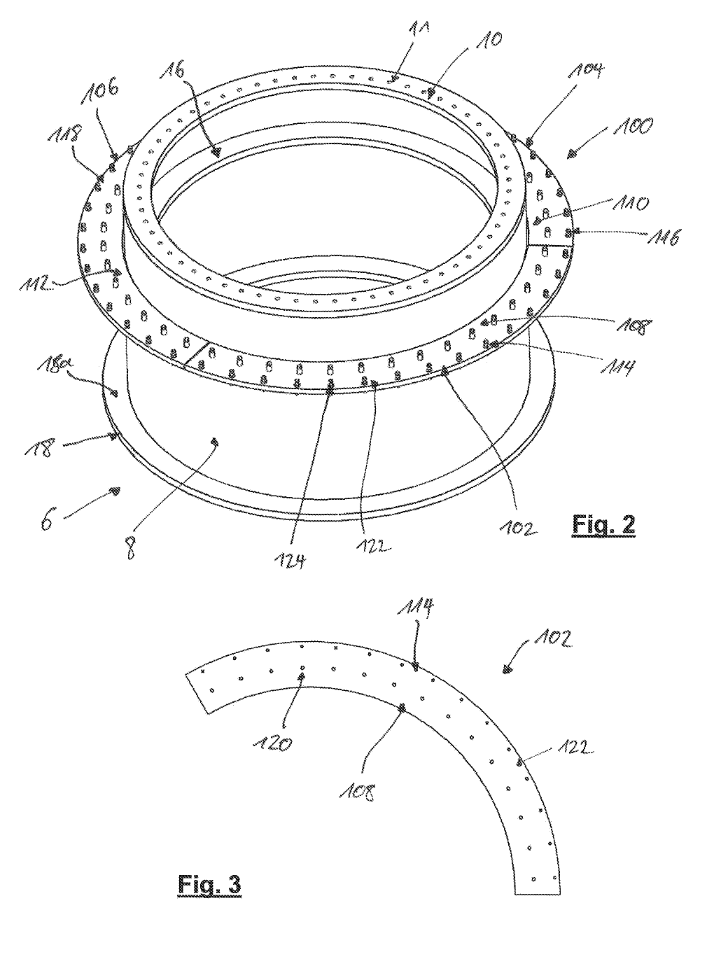

FIG. 2 is a perspective view of a foundation mounting part including a securing device pursuant to a first exemplary embodiment of the invention;

FIG. 3 is a top view of a securing structure pursuant to the first exemplary embodiment of the invention;

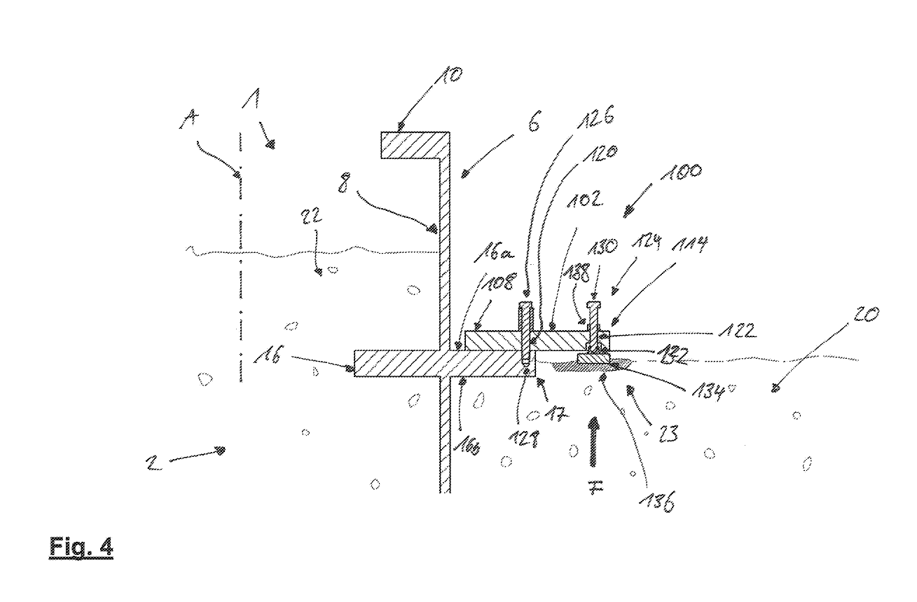

FIG. 4 shows a detail of the sectional view of a foundation mounting part with a securing device pursuant to the first exemplary embodiment arranged thereon;

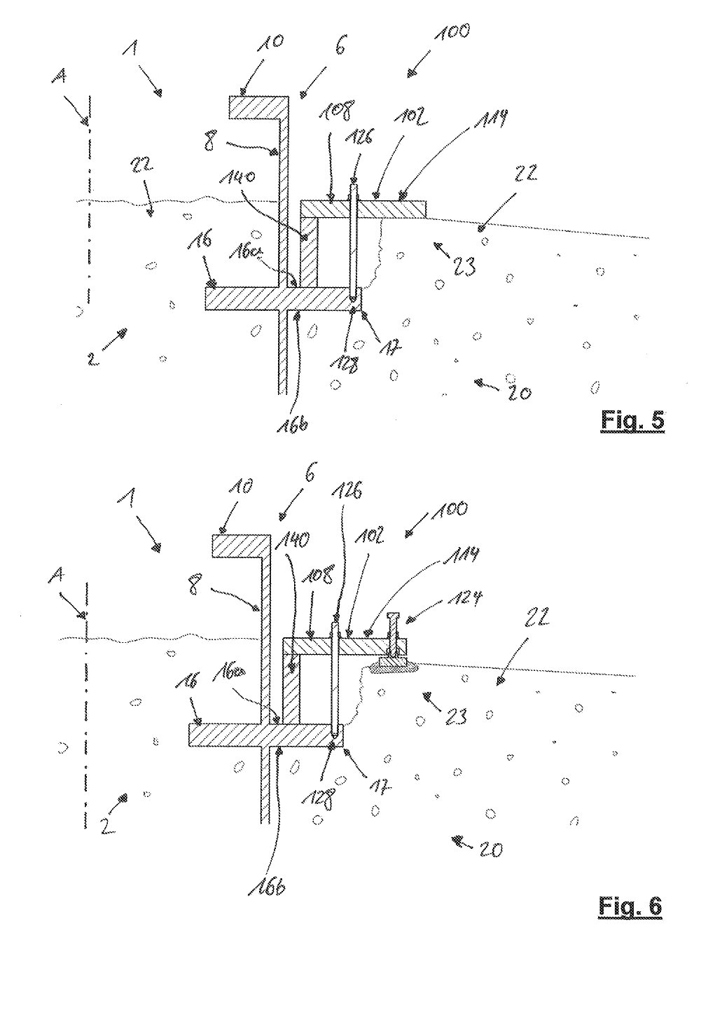

FIG. 5 is a sectional view of a foundation mounting part with a securing device pursuant to a second exemplary embodiment arranged thereon;

FIG. 6 is a sectional view of a foundation mounting part with a securing device pursuant to a third exemplary embodiment arranged thereon;

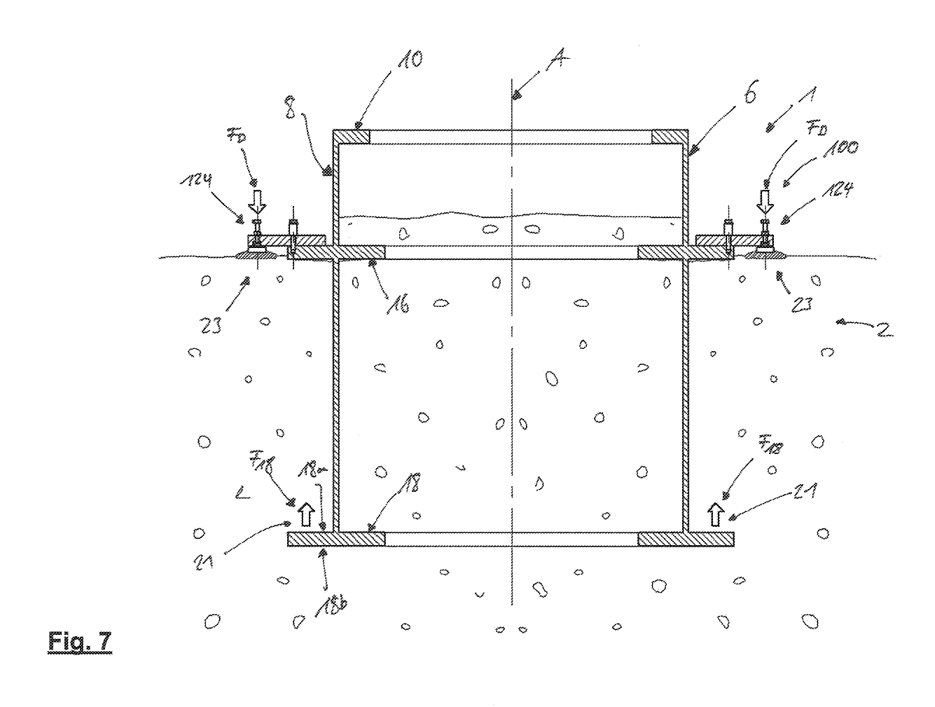

FIG. 7 is a sectional view of a foundation mounting part with a securing device arranged thereon and plotted joint-contact surface compressive loads;

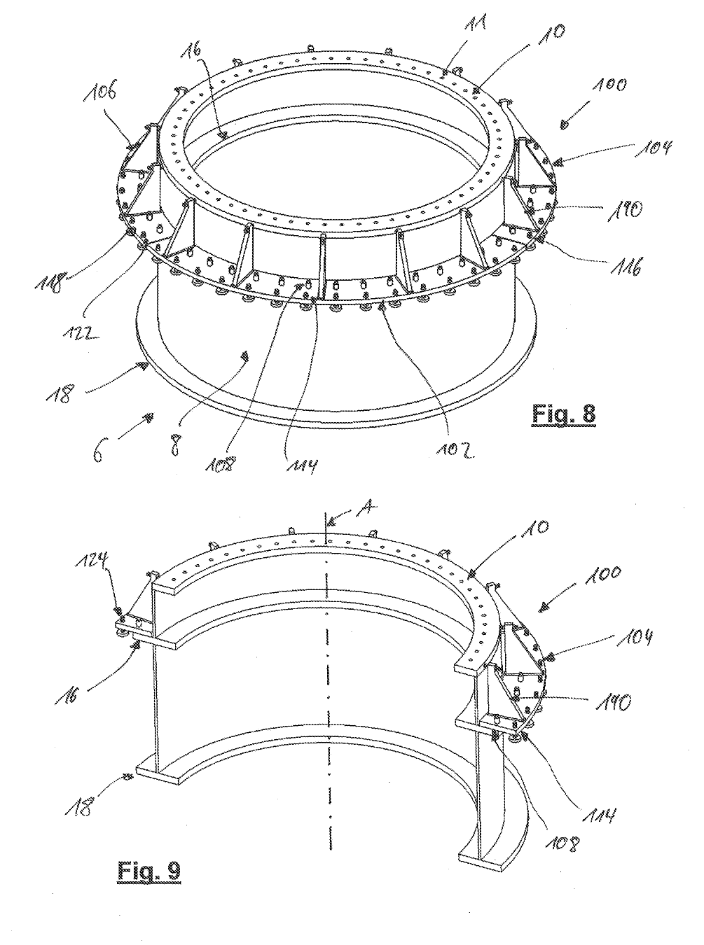

FIG. 8 is a perspective view of a foundation mounting part with a securing device pursuant to a fourth exemplary embodiment arranged thereon;

FIG. 9 is a perspective sectional view of the foundation mounting part including the securing device from FIG. 8; and

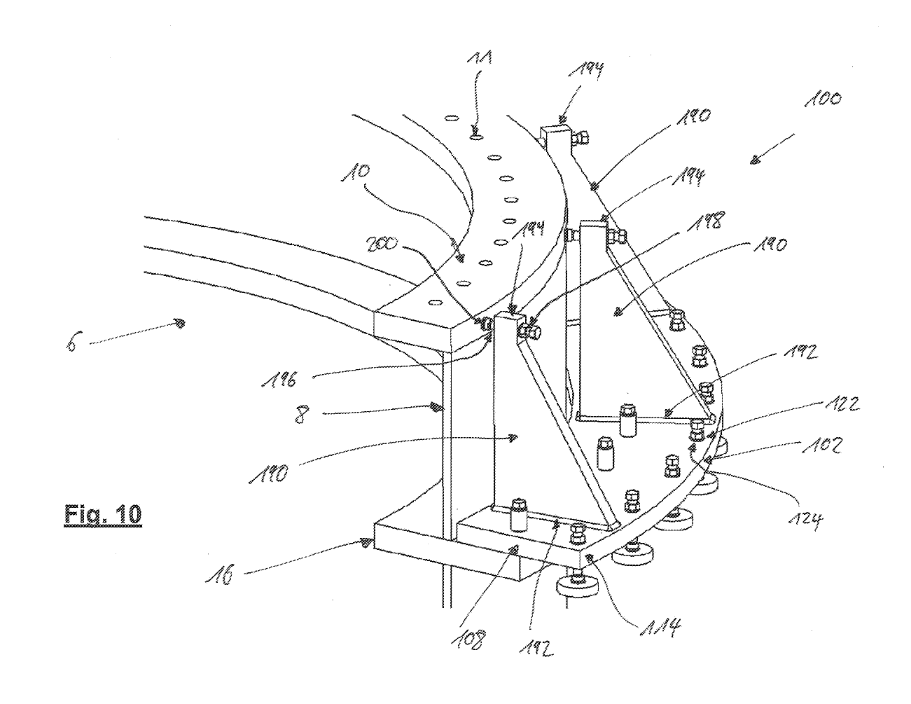

FIG. 10 shows a detail from FIG. 9.

FIG. 1 shows a cross-sectional view of a foundation 1. FIG. 1 shows the typical loads at said foundation 1. Foundation 1 has a concrete structure 2 that is provided in the ground 4. A sub-base is provided on the ground. A foundation mounting part 6 is installed in the concrete structure 2. The foundation mounting part 6 is essentially provided rotation-symmetrically about a central axis A. To this end, the foundation mounting part 6 has a cylindrical base body 8 and a connection flange 10 onto which a tower 14 of a wind turbine (not shown) is flanged by means of a corresponding companion flange 12. The foundation mounting part 6 shows two axially spaced apart extending ring flanges 16, 18, which are arranged inside the concrete structure 2 and form the anchoring elements of the foundation mounting part in the concrete structure 2. The ring flanges 16, 18 both have an upper surface 16a, 18a and a lower surface 16b, 18b. The two ring flanges 16, 18 extend both externally and internally at the base body 8.

As can be seen further below in FIG. 1, a steel reinforcement (which is suggested only schematically) is provided both between the two ring flanges 16, 18 in vertical direction and below the lower ring flange 18. This provides the concrete structure 2 with a steel-reinforced section 20 and a top layer 22, also referred to as top concrete layer, extending in vertical direction from the upper ring flange 16 to the surface 24. Said top layer 22 can absorb foundation forces only to a limited extent.

FIG. 1 furthermore shows the main wind direction in form of arrow 26. In reference to FIG. 1, the main wind direction is from the left. This introduces traction 28 in the section of tower 14 which in reference to FIG. 1 is to the left, whereas a compressive force 30 is introduced on the side of the tower 14 facing away from the wind direction. As a result, a highly stressed pressure contact is created between the surface 16b and the corresponding section of concrete structure section 20 at the lower surface 16b of the upper flange on the side of foundation mounting part 6 facing away from the wind direction, and a not as highly stressed pressure area is created between the upper surface 18a of the lower ring flange on the side of foundation mounting part 6 facing the wind direction. Moreover, the entire mass of the construction that is connected to foundation mounting part 6 weighs on the upper ring flange 16. Now, if cracking 32 occurs in the concrete structure 2 in the area of the ring flanges 16, 18, such cracks and air bubbles can form cavities between the surfaces 16a, 16b, 18a, 18b and the concrete structure 2 because some of the concrete was not fully placed under the upper ring flange 16 during construction of the foundation 1, which reduces the overall stability of the foundation and results in that foundation mounting part 6 can move relative to the concrete structure 2. This can also result in the tower 14 moving which is associated with risks. The upper cracks 32 extend both inside the tower and outside the tower through the top layer concrete and to the surface and are caused by the movement of the upper flange 16. The lower cracks 32 cannot be seen in installed condition, but they protrude downwards from the base of the foundation. They are caused by the shift in load lower flange 18.

The common securing methods and, respectively, remediation methods are aimed at filling the cavities caused by the cracks 32 with a filling material, such as reaction resin concrete or replacing the concrete in said area.

The invention is described with reference to FIGS. 2 to 7. FIG. 2 shows a perspective view of a foundation mounting part 6 which essentially equals the foundation mounting part 6 pursuant to FIG. 1. The foundation mounting part 6 pursuant to FIG. 2 has an essentially cylindrical or tubular base body 8 with two ring flanges 16, 18 extending from it, wherein only that part of the upper ring flange 16 protruding inwards can be seen. Moreover, a connection flange 10 is provided at the upper end of the foundation mounting part 6 having a plurality of through holes 11, so that a tower 14 of a wind turbine (see FIG. 1) can be attached to the foundation mounting part 6.

A securing device 100 is attached to the foundation mounting part 6. The securing device 100 is designed to additionally secure a foundation 1, as shown in FIG. 1, having a foundation mounting part 6 that is incorporated in a concrete structure 2 for holding a construction, in particular a tower 14 of a wind turbine. According to this exemplary embodiment, the securing device 100 has three securing structures 102, 104, 106. Each of the securing structures 102, 104, 106 has a mounting section 108, 110, 112 (see FIG. 3) and a support section 114, 116, 118. The securing structures 102, 104, 106 are attached against an upper surface 16a of the upper ring flange 16 (covered in FIG. 2) by means of the mounting section 108, 110, 112. To this end, the mounting section 108, 110, 112 of the securing structure 102, 104, 106 each has a plurality of through holes 120 (furnished with reference numbers only in FIG. 3) that are provided isochronous and serve for holding screws.

As can be seen already in FIG. 2, and as will be described in more detail with reference to FIGS. 4 to 7, the support section 114, 116, 118 of the securing structures 102, 104, 106 is designed for introducing foundation forces to a section of the concrete structure that is distant of the foundation mounting part 6. According to this exemplary embodiment, this is realized by the support section 114, 116, 118 of the securing structures 102, 104, 106 extending further radially outwards in assembled condition than a radial outer end of the upper ring flange 16. As a result, the support section 114, 116, 118 of the securing structures 102, 104, 106 is radially further away from the central axis A than the outer point of the upper ring flange 16, resulting in that moments acting on the foundation mounting part 6 vertically to longitudinal axis A can be better absorbed.

According to this exemplary embodiment, the securing structures 102, 104, 106 are essentially partially ring-shaped, namely as one-third rings in this case. Other embodiments may also provide for quarter or half rings. This exemplary embodiment prefers the partial ring shape because the foundation mounting part 6 has an essentially cylindrical basic structure. With other foundation mounting parts having, for example, a rectangular basic structure other shapes are preferred for the securing structure 102, 104, 106.

The support sections 114, 116, 118 of securing structures 102, 104, 106 each show a take-up unit 122 for accepting a support unit. According to this exemplary embodiment, take-up unit 122 is designed as a second plurality of through holes and will be described in more detail with reference to FIG. 4. In FIG. 2, the take-up unit 122 is already shown with a support unit 124 arranged therein. According to this exemplary embodiment, each securing structure 102, 104, 106 shows a plurality of support units 124, wherein only one has been furnished with a reference number in FIG. 2.

The connection between the securing device 100 and the foundation mounting part 6 can be seen in detail in the sectional view of FIG. 4. As regards a general view, reference is made to FIG. 7 which will be described in more detail further below. The section of the foundation mounting part 6, which is the upper right section in relation to FIG. 1, is in FIG. 4. Section 22 of the concrete structure 2 has been removed radially outside the foundation mounting part 6 and above the upper ring flange 16, so that section 20 has been exposed. Section 22 is still present inside the foundation mounting part 6. By removing section 22 radially outside the foundation mounting part 6, the upper surface 16a of the upper ring flange 16 is exposed. The securing device 100 is attached to said surface 16a, to which end the mounting section 108 rests on the surface 16a. A fastening screw 126 is led through a through hole 120 in the mounting section 108 of the securing structure 102 and screwed into a tapped blind hole 128 in the ring flange 16. According to this exemplary embodiment, the screw 126 is designed as an M24 screw and can absorb a load of 22 kN. Further screws are provided for but have not been shown, namely 15 per securing structure 102, 104, 106 according to this exemplary embodiment. A certain overlapping between the mounting section 108 and the surface 16a is provided for, so that the screw 126 is essentially loaded under tension and does not experience any moments.

As can be further seen from FIG. 4, the support section 114 projects beyond a radially outer end 17 of the ring flange 16. The support section 114 is arranged vertically above a section 23 of the concrete structure 2 that is distant of the foundation mounting part. The section 23 extending radially outside the end 17 of the foundation mounting part 6 is essentially free from foundation forces and also free from any cracks and the like before the securing device 100 is mounted. It is an intact section of the concrete structure 2. This section 23 is hence particularly suitable for accepting foundation forces, either by proactively attaching the securing device 100 to the foundation mounting part 6, or later on by way of remediation of the foundation 1. According to this exemplary embodiment, the support section 114 has, for example, a radial extension corresponding to the radial extension of the ring flange 16 radially outside the base body 8. This means that support radially outside the base body 8 has approx. doubled thanks to the securing device 100. Force F acting on the securing structure 102 is also shown in FIG. 4 (see FIG. 7 in this regard).

According to this exemplary embodiment, the securing device 100 also has a support unit 124 for better introducing forces to sections 23 which is arranged in a designated take-up unit 122 of the support section 114. According to this exemplary embodiment, the support unit 124 is designed as a pressure screw 130 running through a through hole and having a spherical disk 132 at the root end. A total of 15 pressure screws are provided for per securing structure 102, 104, 106. However, only one such screw is shown in FIGS. 4 and 6 (see also FIGS. 2 and 7). The spherical disk 132 sits on a pressure piece 134, which according to this exemplary embodiment is additionally provided for in section 23 and fixed with a grouting compound 136. The pressure piece 134 introduces a bearing load of the spherical disk 132 into section 23 to prevent the spherical disk 132 from applying a seating stress directly onto the concrete of section 23. Moreover, the pressure piece 134 provides an even seat for the spherical disk 132. The screw 130 is additionally provided with a counter nut 138 to prevent the support unit 124 from accidentally loosening. After mounting the securing device 100, the support unit 124 can be used such as to apply a certain pretension. Thanks to the support unit 124, the foundation mounting part 6 can be lifted at least in part and aligned vertically, if necessary. Moreover, the support unit 124 also provides an opportunity to press an upper surface 18a (not shown in FIG. 4) of the lower ring flange 18 against one section of the concrete structure to establish contact without having to fill cracks with additional concrete or concrete replacement.

FIGS. 5 and 6 show variants of the securing device 100 that is fixed on a foundation mounting part 6. Hereinafter we will essentially describe the differences. Elements that are equal or similar to the first exemplary embodiment pursuant to FIG. 4 will be given the same reference numbers. In this regard, full reference is made to the above description pertaining to the first exemplary embodiment (FIG. 4).

Basically, the exemplary embodiments pursuant to FIGS. 5 and 6 differ from the exemplary embodiment in FIG. 4 in that the securing structure 102 does not rest directly against, but is spaced vertically from, the upper surface 16a of the ring flange 16 in the direction of the central axis A. This has the advantage that the section 22 of the concrete structure 2 must be removed only in part, namely essentially only vertically above the surface 16a. A support block 140 is provided for coupling between the mounting section 108 of the securing structure 102, which can be provided as a compression strut or as a partial ring segment according to the shape of the securing structure 102. The support block 140 transmits a compressive force from the mounting section 108 to the surface 16a. A screw 126 is again provided for fastening purposes. It runs through a through hole in the mounting section 108 and is screwed into a blind hole 128 with a female thread in the ring flange 16. An additional positive connection or substance-to-substance bond between support block 140 and mounting section 108 and/or ring flange 16 is not required although the support block 140 may be attached to the securing structure 102, 104, 106 in one piece in individual embodiments.

According to the exemplary embodiment in FIG. 6, a support unit 124 is provided for in the support section 114 of the securing structure 102, which is identical to the support unit 124 pursuant to the exemplary embodiment in FIG. 4. Therefore, reference is made to the above description.

No support unit is provided for in the exemplary embodiment pursuant to FIG. 5. Instead, the support section 114 of the securing structure 102 rests directly on a surface of section 23 of the concrete structure 2. This embodiment may be preferred depending on the condition of the surface of section 23 and the forces to be absorbed, because it helps to avoid additional elements. In that case, a pretension can be achieved by the screw 126 because, thanks to pressure piece 140, the mounting section 108 does not have to rest evenly on the surface 16a. This also means that the foundation mounting part 6 can be lifted by means of the screw 126 in the exemplary embodiment of FIG. 5 and that an upper surface 18a of the lower ring flange 18 can be hence pressed against the concrete structure 2.

FIG. 7 once again illustrates how the securing device 100 is pretensioned by means of the support unit 124. FIG. 7 shows a full section view of a foundation 1 and a foundation mounting part 6 installed therein. The securing device 100 is designed in accordance with the first exemplary embodiment of FIG. 4. In FIG. 7, the support unit 124 is pretensioned such that a compressive force F_{D} is applied to section 23 of the concrete structure 2 by means of the support unit 124. As a result, the foundation mounting part 6 is pulled up with reference to FIG. 7 so that the upper surface 18a of the lower ring flange 18 is pressed against a section 21 of the concrete structure 2. This is indicated by flange force F₁₈. Now, if the tower is loaded as shown in FIG. 1, a lifting of the upper surface 18a off section 21 of the concrete structure 2 is avoided, which increases stability.

FIGS. 8 to 10 show a fourth exemplary embodiment of the invention. Identical and similar elements are marked with the same reference numbers as in the first three exemplary embodiments. In this regard, full reference is made to the above description pertaining to the first three exemplary embodiments.

The foundation mounting part 6 pursuant to FIGS. 8 and 9 corresponds in essence to the foundation mounting part 6 pursuant to FIGS. 1 and 2. The foundation mounting part 6 pursuant to FIGS. 8 and 9 has an essentially cylindrical or tubular base body 8 with two ring flanges 16, 18 extending from it, wherein only that part of the upper ring flange 16 protruding inwards can be seen. Moreover, a connection flange 10 is provided at the upper end of the foundation mounting part 6 having a plurality of through holes 11, so that a tower 14 of a wind turbine (see FIG. 1) can be attached to the foundation mounting part 6.

The support sections 114, 116, 118 of securing structures 102, 104, 106 each show a take-up unit 122 for accepting a support unit. According to this exemplary embodiment, take-up unit 122 is designed as a second plurality of through holes. In addition, the securing structures 102, 104, 106 show one several reinforcing braces provided as gusset plates 190 in this case (only one bearing a reference number in FIGS. 8 and 9) to counter any deformation of the securing structures 102, 104, 106 and hence unwanted “sagging” of the foundation mounting part 6. According to this exemplary embodiment (FIGS. 8 to 10), five gusset plates 190 are arranged at each securing structure 102, 104, 106, meaning that the securing device 100 has a total of 15 gusset plates 190. The details are provided in FIG. 10, which will be described further below.

FIG. 10 shows a detailed perspective view of the upper area of a foundation mounting part 6 with its connection flange 10 and upper ring flange 16 and of the securing device 100 pursuant to the fourth exemplary embodiment. Moreover, FIG. 10 shows three gusset plates 190 extending vertically to a flat extension of the securing structure 102 and arranged thereon. The gusset plates are affixed to the securing structure 102, 104, 106 by means of a welded web splice in form of a double fillet weld 192. The gusset plates 190 each show a contact section 194 with which they rest on the connection flange 10 of the foundation mounting part 6. Furthermore, the contact section 194 has a support unit 196 which pursuant to this exemplary embodiment is designed as a pressure screw 198 with a spherical disk 200, to which end the upper area of the gusset plate preferably includes a female thread. The pressure screw 198 is screwed through said female thread to create a frictional connection between the connection flange 10 and the reinforcing brace with the screw foot and a suitable spherical disk 200. Thanks to the pressure screw 198, it is possible to realize an axial pretension of the securing structure 102, 104, 106 by adjusting the incline of the respective gusset plate 190 in relation to axis A. The support unit 196 is basically designed like support unit 124. Therefore, reference is made to the above description of support unit 124. Even though support units 124 are provided for at support section 114, 116, 118 in this exemplary embodiment (FIGS. 8 to 10), it is to be understood that this is not mandatory. The support section 114, 116, 118 may be just as well designed in accordance with the third exemplary embodiment (FIG. 4).

1. Securing device (100) for additionally securing a foundation (1) having a foundation mounting part (6) that is incorporated in a concrete structure (2) for holding a construction (14), in particular a tower of a wind turbine, wherein the securing device (100)
has at least one securing structure (102, 104, 106) with a mounting section (108, 110, 112) and a support section (114, 116, 118),
wherein the mounting section (108, 110, 112) is provided for attaching the securing structure (102, 104, 106) to the foundation mounting part (6) and
the support section (114, 116, 118) is provided for introducing foundation forces to a section (23) of the concrete structure (2) that is distant of the foundation mounting part (6).

2. The device according to claim 1, wherein a maximum outer diameter of the securing device (100) is bigger than a maximum outer diameter of the foundation mounting part (6).

3. A device according to claim 1, wherein the securing structure (102, 104, 106) is designed as a ring segment, in particular as a half, third, or quarter ring segment and is preferably essentially even.

4. A device according to claim 1, wherein the mounting section (108, 110, 112) shows a first plurality of through holes (120) for accepting fasteners for fastening the securing structure (102, 104, 106) to the foundation mounting part (6).

5. A device according to claim 1, wherein at least one reinforcing brace is arranged at the securing structure (102, 104, 106) having one contact section (194) that is provided to rest on one section of a foundation mounting part and/or on one construction arranged thereon.

6. A device according to claim 1, wherein the support section (114, 116, 118) of the securing structure (102, 104, 106) shows at least one take-up unit (122) for a support unit (124), wherein the take-up unit (122) preferably shows a second plurality of through holes.

7. The device according to claim 6, wherein the contact section (194) of the reinforcing brace shows at least one support unit (196).

8. The device according to claim 6, wherein the support unit (124, 196) shows at least one pressure screw (130) with a spherical disk (132).

9. A device according to claim 6, wherein the support unit (124, 196) shows at least one of the following:
a hard rubber body;
a spring element, in particular a disk spring;
a hydraulic cylinder;
a vibration absorber;
a mounting foot; and/or
a pair of tensioning wedges.

10. A device according to claim 1, wherein the support section (114, 116, 118) of the securing structure (102, 104, 106) is provided to rest directly on the section (23) of the concrete structure (2) that is distant of the foundation mounting part (6).

11. Foundation (1) for a construction (14), in particular a tower of a wind turbine, having:
a concrete structure (2) and
a foundation mounting part (6) incorporated in the concrete structure (2) having a base body (8) at which at least one ring flange (16, 18) extends that serves as an axial anchoring for the foundation mounting part (6) in the concrete structure (2), wherein the central axis (A) of the foundation mounting part (6) is essentially in-stalled in vertical direction,
characterized by a securing device (100) according to claim 1.

12. A foundation according to claim 11, wherein at least one pressure piece (134) for transmitting foundation forces from the support section (114, 116, 118) into the concrete structure (2) is provided between the support section (114, 116, 118) and the concrete structure (2), which is attached to the section (23) of the concrete structure (2) that is distant of the foundation mounting part (6) preferably by means of a grouting compound (136) in an essentially horizontal direction.

13. Method for securing a foundation (1) for a construction (14), in particular a tower of a wind turbine, having:
a concrete structure (2) and
a foundation mounting part (6) incorporated in the concrete structure (2) having a base body (8) at which at least one ring flange (16, 18) extends that serves as an axial anchoring for the foundation mounting part (6) in the concrete structure (2), wherein the central axis (A) of the foundation mounting part (6) is essentially in-stalled in vertical direction, including the step of:
having the foundation mounting part (6) rest on a section (23) of the concrete structure (2) that is distant of the foundation mounting part (6).

14. Method according to claim 13, wherein at least two axially spaced apart ring flanges (16, 18) extend at the base body (8), including the step of:
pressing the upper surface (18a) of the lower ring flange (18) against one section (21) of the concrete structure (2).

15. Method according to claim 13, wherein at least two axially spaced apart ring flanges (16, 18) extend at the base body (8), including at least one of the following steps:
bracing the foundation mounting part (6) upward in vertical direction.
exposing an upper surface (16a) of the upper ring flange (16);
adding a plurality of threaded holes (128) to the upper surface (16a) of the upper ring flange (16);
pressing, by means of a support unit (124), against the support section (114, 116, 118) to brace the foundation mounting part (6);
arranging at least one pressure piece (134) on a surface of the section (23) of the concrete structure (2) that is distant of the foundation mounting part (6).
